(19) United States
(12) Patent Application Publication
(10) Pub. No.: US 2015/0102147 A1
(43) Pub. Date: Apr. 16, 2015

(54) CHIPPER TRUCK AND TRAILER

(71) Applicant: Dennis A. Anderson, Kent, OH (US)

(72) Inventor: Dennis A. Anderson, Kent, OH (US)

(21) Appl. No.: 14/511,573

(22) Filed: Oct. 10, 2014

Related U.S. Application Data
(60) Provisional application No. 61/891,613, filed on Oct. 16, 2013.

(51) Int. Cl. B02C 21/02

(52) U.S. Cl. CPC B02C 21/02
USPC 241/101.741

(57) ABSTRACT

A chipper truck and trailer assembly for tree trimming and removal includes a truck having a cab and a bed frame. The truck also has a chipper box mounted thereon and open at an end thereof. A trailer is removably connected to the end of the truck adjacent the open end of the chipper box and maintains thereon a chipper unit with a feed chute and a discharge chute. The feed and discharge chutes are at an obtuse angle to each other such that operator may stand alongside the trailer, rather than behind it. The discharge chute is directed into the chip box. A drive shaft interconnects an auxiliary PTO taken from the truck transmission and a power input to the chipper unit.

### CROSS-REFERENCE TO RELATED APPLICATION

This application claims the benefit of pending U.S. provisional application Ser. No. 61/891,613, filed Oct. 16, 2013, by the same title, which is fully incorporated herein by reference.

### TECHNICAL FIELD

The invention herein resides in the art of mobile units or devices adapted for providing on-site work, while being readily transported to and from the work site. More particularly, the invention relates to a truck having a selectively interconnected trailer assembly, both the truck and trailer being adapted for implementation in the work effort. More specifically, the invention relates to a mobile lift and chipper unit particularly suited for tree trimming and removal, wherein the unit includes a truck providing a lift mechanism and chip box, and a trailer removably attachable to the truck, the trailer having a chipper unit driven by a power takeoff of the truck.

### BACKGROUND ART

Truck units for use in tree trimming and removal are now commonly known. Typically, such truck units include a truck having a cab and bed frame, the bed frame having a chip box fixedly secured thereto, along with a hydraulic lift arm and bucket mechanism for lifting workers into proximity of tree portions intended for removal. This truck and chip box unit has also typically included a mobile chipper unit adapted for coupling and decoupling thereto by means of a trailer hitch on the truck unit and an extended tongue and ball receiver on the chipper unit. The mobile chipper unit is self-contained, with its own significant power unit.

The self-contained nature of the mobile chipper unit makes it costly to purchase and maintain. Additionally, the prior art units included risks inherent with an inline feed chute and discharge chute. When trimming or removing trees along a roadway, the workers are typically required to stand in the street to feed tree branches and the like into the feed chute, subjecting them to risks of vehicle injuries.

There is a need in the art for an improvement over such prior systems, increasing the efficiency of their implementation and safety in their use.

### SUMMARY OF THE INVENTION

In light of the foregoing, it is a first aspect of the invention to provide a chipper truck and trailer assembly in which the chipper is powered by the aerial unit truck's engine.

Other aspects of the invention are achieved by a chipper truck and trailer assembly unit for tree trimming and removal in which the chipper unit is mounted on a trailer pulled by an aerial unit truck.

A further aspect of the invention is achieved by the provision of a chipper truck and trailer assembly in which the feed chute and discharge chute of the chipper unit are not aligned with each other.

Still a further aspect of the invention is the provision of a chipper truck and trailer assembly in which the feed chute is angled with respect to the discharge chute, such that workers may stand out of the roadway when introducing tree portions thereunto.

Still a further aspect of the invention is the provision of a chipper truck and trailer assembly in which the truck is provided with an auxiliary power takeoff for coupling with a trailer-mounted chipper hitched to the truck.

Yet another aspect of the invention is the provision of a chipper mounted aerial unit for tree trimming and removal that employs a chipper that may be driven by a PTO from an associated truck, eliminating the need of a separate power pack.

A further aspect of the invention is the provision of a chipper mounted aerial unit for tree trimming and removal that is economical in use and easy to construct using presently known elements and techniques.

The foregoing and other aspects of the invention that will become apparent as the detailed description proceeds are achieved by a chipper truck and trailer assembly, comprising: a truck unit having an auxiliary power takeoff from the vehicle drive transmission, such power takeoff being presented at a rear end of the truck; a trailer assembly removably connected to the truck and maintaining a wood chipper thereon, the wood chipper having a power input unit; and a drive shaft interconnecting said power input unit with said auxiliary power takeoff of the truck.

### DESCRIPTION OF DRAWINGS

For a complete understanding of the objects, techniques and structure of the invention, reference should be made to the following detailed description and accompanying drawings wherein:

FIG. 1 is a side elevational view of the chipper truck and trailer assembly of the invention; and

FIG. 2 is a bottom plan view of the chipper truck and trailer assembly of the invention.

### DETAILED DESCRIPTION OF PREFERRED EMBODIMENTS

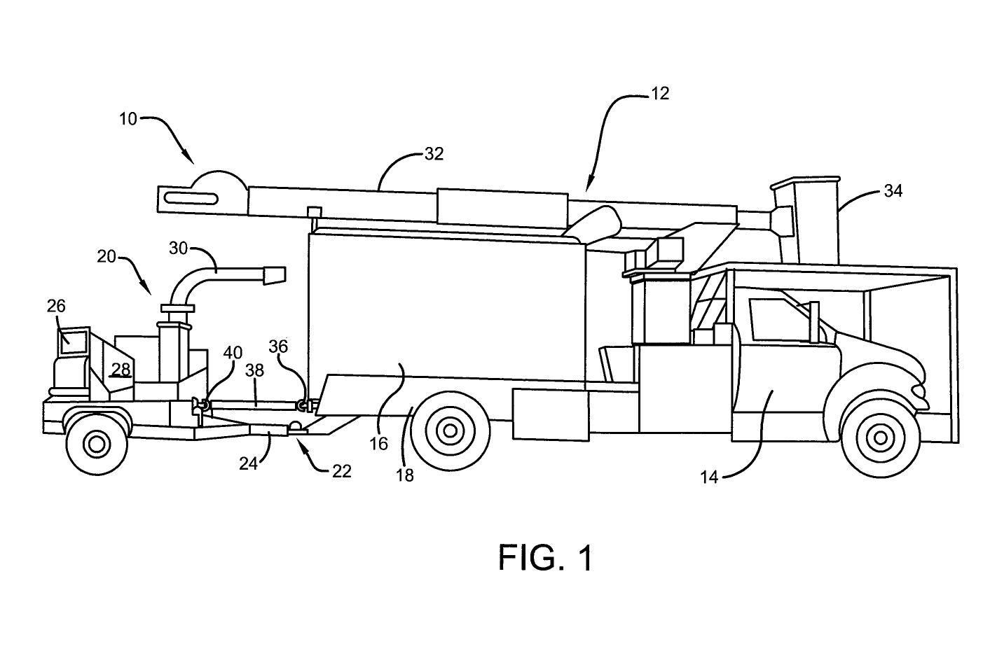

Referring to the drawings and more particularly FIG. 1, it can be seen that a chipper truck and trailer assembly made in accordance with the invention is designated generally by the numeral 10. The assembly 10 includes a truck 12, preferably a truck having an aerial unit including a hydraulic lift arm and bucket mechanism for lifting workers into proximity of tree portions intended for removal. The truck 12 includes a cab 14 for transporting workers. In somewhat standard fashion, a chip box 16 is mounted to a bed frame 18 of the truck 12.

A wheel mounted chipper unit 20 is removably connected to the truck 12 by means of a trailer hitch assembly 22. A tongue 24 extends from the trailer hitch to the frame of the wheel mounted chipper assembly 20, as shown.

A feed chute 26 is provided in communication with a chipper section 28, which discharges through a discharge shoot 30, as shown. Most preferably, the feed chute 26 is mounted at a side of the chipper unit assembly 20 and angled with respect to a longitudinal axis of the truck 12 and wheel mounted chipper unit 20 such that branches, debris and the like can be introduced into the feed chute 26 from the side with workers standing off of the roadway, in contradistinction to the prior art. The discharge chute 30 is preferably substantially axially aligned with the longitudinal axis of the truck 12 and chipper unit 20 and is positioned to discharge the wood chips and the like into the chip box 16. The discharge chute 30 may be adjustable to achieve the desired communication with the chip box. Typically, the feed chute 26 and discharge chute 30 form an obtuse angle, the primary concern being the positioning of the feed chute 26 such that workers may stand alongside the unit 10, rather than behind it. In that regard, the feed chute 26 is preferably on the “curb side” of the chipper truck and trailer assembly 10.

As mentioned earlier, the chipper truck and trailer assembly 10 is typically of an aerial nature, including a hydraulic lift arm assembly 32 having a bucket 34 connected to an end thereof This type of structure, well known in the art, allows workers to be elevated into and/or adjacent tree limbs to accommodate trimming and removal.

A power takeoff unit (PTO) 36 is provided at the rear end or bumper area of the truck 12 and is preferably driven by the engine of the truck to provide power to the chipper section 28 to control its operation. To that end, a drive shaft 32 is interconnected between the PTO 36 and an appropriate input drive 40 of the chipper section 28.

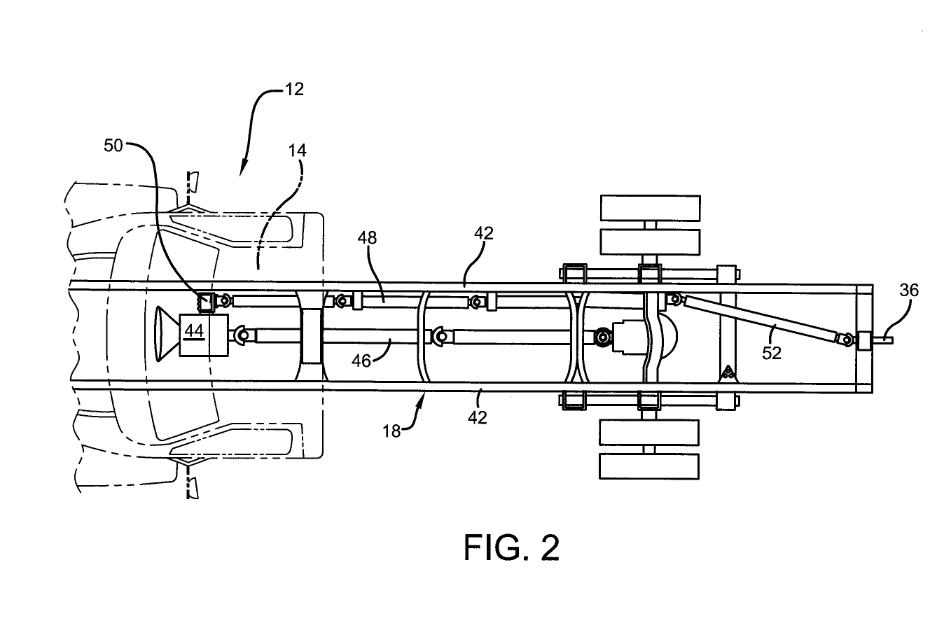

With reference now to FIG. 2, an appreciation of the development and provision of the PTO 36 can be obtained. As shown, beams or rails 42 are provided longitudinally along the sides of the truck 12, supporting the cab 14, engine and the like at a front end thereof and the bed frame 18 and chip box 16 at a rear end. As shown, a transmission 44 for the truck 12 has a main vehicle drive shaft 46 extending therefrom for driving the wheels of the truck. An auxiliary drive shaft 48 is connected to the transmission 44 through a PTO 50 and extends in parallel with the drive shaft 46 to a point near the rear of the bed frame 18 supported by the rails 42, at which point a final link 52 is provided in a position between the main portion of the drive shaft 48 and the PTO 36. This final link 52 is interconnected by appropriate universal joints or the like to accommodate the positioning of the PTO 36 centrally at the rear of the truck 12 and appropriately supported by frame members and the like.

It should be apparent from the foregoing that the invention provides a chipper truck and trailer assembly that is cost effect to construct and maintain, having a single drive unit for both the vehicle and the chipper assembly, and is safe in operation. The chipper unit, being trailer mounted, may be readily connected and disconnected with regard to the truck. The chipper discharge chute is in line with the truck's chipper box, and the truck and trailer assembly may be positioned curb-side such that workers do not have to enter the roadway.

While in accordance with the patent statutes only the best mode and preferred embodiment of the invention has been presented and described in detail, the invention is not limited thereto or thereby. Accordingly, for an appreciation of the scope and breadth of the invention reference should be made to the following claims.

What is claimed is:

1. A chipper truck and trailer assembly, comprising:
a truck unit having an auxiliary power takeoff from the vehicle drive transmission, such power takeoff being presented at a rear end of the truck;
a trailer assembly removably connected to the truck and maintaining a wood chipper thereon, the wood chipper having a power input unit; and
a drive shaft interconnecting said power input unit with said power takeoff of the truck.

2. The chipper truck and trailer assembly according to claim 1, wherein said wood chipper has a feed chute and a discharge chute.

3. The chipper truck and trailer assembly according to claim 2, wherein said discharge chute is in substantial alignment with a central axis of said truck.

4. The chipper truck and trailer assembly according to claim 3, further comprising a chipper box mounted to said truck and in operative communication with said discharge chute.

5. The chipper truck and trailer assembly according to claim 4, wherein said discharge chute is adjustable for a desired communication with said chip box.

6. The chipper truck and trailer assembly according to claim 4, wherein said feed chute is positioned on a curb side of said trailer assembly.

7. The chipper truck and trailer assembly according to claim 6, wherein said feed chute and discharge chute are oriented at an obtuse angle with each other.

8. The chipper truck and trailer assembly according to claim 6, wherein said auxiliary power takeoff is driven by an auxiliary drive shaft.

9. The chipper truck and trailer assembly according to claim 8, wherein said auxiliary drive shaft parallels a vehicle drive shaft of said truck and then angles through universal joints to said auxiliary power takeoff centrally at said rear end of said truck.

10. The chipper truck and trailer assembly according to claim 9, wherein said trailer interconnects with said truck through said auxiliary power takeoff and a trailer hitch assembly.
